(19) United States
(12) Patent Application Publication
(10) Pub. No.: US 2014/0209515 A1
(43) Pub. Date: Jul. 31, 2014

(54) Blended Regolith Simulant Material and Method of Making the Material

(71) Applicants: Otis R. Walton, Livermore, CA (US); Brian Comaskey, Walnut Creek, CA (US); Ali Ismail Abdel-Hadi, Auburn, AL (US)

(72) Inventors: Otis R. Walton, Livermore, CA (US); Brian Comaskey, Walnut Creek, CA (US); Ali Ismail Abdel-Hadi, Auburn, AL (US)

(21) Appl. No.: 13/754,859

(22) Filed: Jan. 30, 2013

(51) Int. Cl. G01N 1/28; B07B 1/00

(52) U.S. Cl. CPC G01N 1/28; B07B 1/00
USPC 209/10; 252/408.1; 524/585

(57) ABSTRACT

A method includes the steps of blending a first part comprising a low-density fine particulate material additive with a second part comprising original regolith simulant material for producing a lower bulk density blended regolith simulant material having gravity-driven flow properties that resemble those that the original regolith material would have under a reduced gravity of a target extraterrestrial body. The blended regolith simulant material includes one part by volume of original regolith simulant material to N parts by volume of a low-density fine particulate material additive, where N is generally greater than one less than the ratio of the gravitational acceleration on the surface of the earth to the gravitational acceleration on the surface of the target extraterrestrial body.

### FEDERALLY SPONSORED RESEARCH OR DEVELOPMENT

This invention was made with Government support under contracts NNX109CE77P and NNX10CD28P awarded by NASA. The Government has certain rights in this invention.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the field of lunar and planetary soils or regoliths. More particularly, the invention relates to the use of terrestrial, soil-like simulants for lunar or planetary regoliths.

### BACKGROUND OF THE INVENTION

It has been 40 years since NASA's last manned mission to the lunar surface (Apollo 17, with astronauts Cernan and Schmidt); however, several nations around the world are currently making plans for manned missions to the moon and other solar system bodies over the next two decades. Several robotic missions to the moon and mars have already taken place, and many more are being planned to those bodies and to moons of other planets, to asteroids, to comets, and to other extraterrestrial bodies. Many lunar surface systems will face the challenge of dealing with the lunar regolith in unprecedented ways, including surface traversing, drilling, excavating, crushing and transporting of regolith, introducing regolith into chemical processors and mitigating dust accumulation. These challenges are made more formidable by the lunar environment, which has characteristics including low gravity (e.g., ˜⅙g), low vacuum (e.g., ˜10⁻¹² Torr), and very wide temperature ranges (e.g., −230° C. to +120° C.).

Most of the lunar surface is covered with regolith, a mixture of fine dust and rocky debris produced by meteor impacts, and varies in thickness from about 5 m on mare surfaces to about 10 m on highland surfaces. The bulk of the regolith is a fine gray soil with a bulk density of about 1.5 g/cm³, with a pycnometer ‘grain’ density of about 2.7 g/cm³. Regolith also contains breccia and rock fragments from the local bedrock [Carrier et al, 1991; Taylor et al, 2005] as well as irregular agglutinate particles formed by micro-meteorite impacts. The large number of very fine particles increases the surface area per unit mass, and thus the surface energy per unit mass available for cohesive forces to act in the bulk material. Also, the absence of air and water has allowed the fines to remain in the regolith as a greater percentage of the mass than would be typical of terrestrial geologic deposits. Chapter 9 of The Lunar Sourcebook [Carrier et al., 1991] states that “roughly 10% to 20% of the [lunar] soil is finer than 20 μm, and a thin layer of dust adheres electrostatically to everything that comes in contact with the soil: spacesuits, tools, equipment, and lenses.”

The surface of Mars also has very fine particulate matter covering much of its surface; however, because Mars has a thin atmosphere, which transports fine dust particles over great distances, and portions of the Martian atmosphere freeze and sublime each year, the Martian regolith composition differs considerably from that of the moon. Other solar system bodies, without atmospheres, are expected to have significant surface fines created by meteorite impacts over the eons. When robotic exploration missions land on these bodies, much more can be learned about the characteristics of their surface regoliths.

In order to generally ensure the success of future lunar missions, extensive testing will need to be performed with materials that are as close as possible to the regoliths that will be encountered and under conditions that are as close as possible to those anticipated to exist on the lunar surface. Similar challenges face designers of Mars or other extraterrestrial exploration missions. Given the complex nature of lunar materials and their diversity across the different regions with respect to mineralogy, chemical compositions, maturity and local environmental effects, it is not possible to define a single material to serve as a simulant for all lunar regolith materials. However, the present state of knowledge of lunar geological history and the physical evidence provided by the lunar samples collected, allow experts to discern the major characteristics of the lunar regolith depending upon the region of origin and local environment. Based on that knowledge it is estimated that between five and ten simulant materials will be adequate to meet the requirements for proper technology development and testing for lunar surface mission systems. To properly select technologies that will operate and survive on the lunar and Martian surfaces, scientists and engineers must account for the unique characteristics of the surface regoliths and rocks that will be encountered. Challenges that occurred during the Apollo missions in maintaining the Lunar Roving Vehicle (LRV) and astronauts' extra-vehicular activity (EVA) suits, equipment seals, and drilling equipment clearly illustrate the need for comprehensive testing of surface equipment with simulant materials that are a close approximation of the surface materials to be encountered.

A limited inventory of lunar material exists from the Luna and Apollo missions of 40 years ago. This lunar sample inventory is priceless and its use in destructive testing is very limited. Thus, the development of lunar simulants is needed to support the engineering and scientific communities' need for consumable rock and soil material that duplicate as many properties of the lunar regolith as is technically and economically feasible. This degree of duplication is referred to as the fidelity of the simulant. The need is to have simulants produced from terrestrial rock and mineral sources that approach those of lunar materials in terms of chemistry and mineralogy, as well as physical and geotechnical properties. A variety of lunar simulants have been developed over the years, and several new, higher-fidelity simulants are under development. Table 1 [Gaier, 2008; Schrader et al, 2008] lists some of the better-known lunar simulants. Each of these simulants attempts to replicate the particle size distribution, as well as the mineral and chemical composition, and the geotechnical behavior of the target regolith. Some of these simulants are comprised of as many as 10 separate components in order to replicate the chemical composition and trace minerals in lunar regolith. The simulants targeted primarily toward the physical or geotechnical properties of lunar regolith are often less complex and also less precise in the number of trace mineral components included. All of the simulants contain a wide size distribution, with a large fraction of the material smaller than 50 μm, with most of the simulants having nearly the same fines fraction as typical lunar regolith (e.g., 10% to 20% of the simulant finer than 20 μm in size). Inclusion of this very fine fraction of the particle size distribution is considered an important factor in achieving high-fidelity in the physical or geotechnical behavior of the simulant, because it is well recognized that the cohesive character of fine silty soils is often determined by the finest particles in the soil, especially those fines comprising the smallest 20% of the mass of the soil.

TABLE 1
Well-Known Lunar Regolith Simulants

| Label | Source, purpose/or organization | Source Material | region | Date |
|---|---|---|---|---|
| | Basaltic dust | | | 1967 |
| MLS-1 | Minnesota Lunar Simulant (mare)/U. Minn | Basalt sill, Duluth | Mare | 1988 |
| | | complex | | |
| MLS-2 | Minnesota Lunar Simulant (mare)/U. Minn | Basalt sill, Duluth | Highlands | 1988 |
| | | complex | | |
| JSC-1 | NASA baseline simulant (mare)/JSC | Basalt ash, San Francisco | Mare | 1993 |
| | | field, AZ | | |
| FJS-1 | Japanese mare simulant with ilmenite | Mt Fuji area basalt | Mare | 1998 |
| | JAXA, LETO | | | |
| MKS-1 | Japanese mare simulant with ilmenite | | Mare | 1998 |
| JSC-1A | Mimic of JSC-1/Orbitec | Basalt ash, San Francisco | Mare | 2006 |
| | | field, AZ | | |
| OB-1 | Canadian highlands simulant, | Shawmere anorthosite, | Highlands | 2007 |
| | Geotechnical | olivine slag | | |
| | | glass/NORCAT | | |
| NU-LHT | NASA/USGS Lunar Highlands Simulant | Stillwater mine, MT & | Highlands | 2008 |
| series | | commercial minerals | | |
| CAS-1 | Chinese Academy of Science | Jinlongdingzi scoria cone | Mare | — |
| NOA-1 | National Astronomical Observatories, | Gabbro (source?) | Highlands | — |
| | Chinese Academy of Science | | | |

During NASA's manned lunar missions a great deal was learned about lunar regolith, and about potential problems that can be caused by fine dust in a lunar environment. Much of the lunar regolith was found to be mechanically similar to terrestrial fine dry silty soils with wide size distributions. Lunar regolith was also found to be ‘weakly cohesive’; however, under in-situ lunar conditions, it would stick to everything. Recent simulations, drop tower tests, and centrifuge tests have demonstrated that granular materials tend to act more cohesively at reduced gravity. This change in behavior at reduced gravity, is not due to a change in cohesive strength of the material, rather it is due to a reduction in the gravity driving force causing material to flow. Among the behavior changes observed in these experiments and simulations are phenomena such as larger clumping and larger avalanche sizes in rotating drum flows under low gravity and reduced flow rates and/or flow stoppages out of hoppers under reduced gravity. The large fine-fraction and potentially increased surface energies of in-situ regolith material already increase the likelihood of flow stoppages or no-flow conditions occurring in in-situ resource utilization processing equipment, such as oxygen production from regolith. The additional risk of flow stoppage conditions occurring because of reduced gravity driving forces is difficult to test terrestrially.

NASA has long described the state of an emerging technology using a scale known as technology readiness levels (TRLs) [Mankins, 1995]. Before a new technology development effort can be transferred to a NASA flight program, it must at least be at TRL-6, wherein the “System/subsystem model or prototype [has been] demonstrated in a relevant environment (ground or space)” [italics added]. It has long been recognized that an important component of the lunar environment is the reduced lunar gravity. Of particular concern with regolith excavation, handling, and processing equipment is the fact that most conventional terrestrial equipment designs rely on gravity to provide much of the driving force for a material to move or flow from one hardware component to the next. Multiple researchers have demonstrated that granular materials behave more cohesively under reduced gravity than they do under a ‘normal’ terrestrial gravity environment [e.g., Walton, 2007; Mueller, 2009]. This apparent higher cohesivity at reduced gravity is primarily because the driving force causing material to flow is reduced, thus making the material appear to behave like a material with higher cohesive strength. Recognition of this effect of higher apparent cohesivity under reduced gravity has led to a need for testing of regolith handling equipment under reduced gravity conditions in order to generally assure that the equipment will function as intended when it is actually deployed at low-gravity. The availability of reduced gravity environments is extremely limited. There are very few experimental methods capable of simulating reduced gravity without the expense of a space launch. One method involves a drop tower, wherein an experimental chamber is dropped from a high tower (usually in a vacuum or low-pressure tube) to provide a few seconds (e.g., up to ˜4 s) of nearly zero-g before arresting the fall at the bottom. A non-zero gravity environment can be simulated in such a drop-tower by having a rotating experiment cell which can produce a simulated gravity body-force, due to the rotational centrifugal force, which can match a desired reduced gravity level, at least at one radial distance away from the axis of rotation [Brucks, 2008]. A less restrictive way of producing a reduced gravity environment is to fly an aircraft in a parabolic path (i.e., inclined up to an apex and then down) such that a nearly-fixed fraction of gravity is maintained over the entire interior of the aircraft for time periods up to 30 seconds, or even slightly longer for flight-simulated g-levels that are a significant fraction of terrestrial gravity, such as Martian gravity simulation flights, which are typically (˜⅓ g). NASA provides such environments on a competitive basis to a few researchers each year, and commercial reduced and zero-gravity-experience flights exist; however, commercial flights are seldom made available for testing prototype equipment. The g-levels available in parabolic flights can vary from zero to 2-g; however, these flights are expensive, require significant advance planning and preparation, and have very limited availability.

Thus, there is a significant need for a method to test potential ideas for material handling and flow equipment designs early in the development stage, when a simple, quick, lab-scale test may be used to determine whether a potential material handling idea has merit. It would be a significant benefit to potential equipment designers if they could perform flow/no-flow tests for regolith under simulated low-gravity, as soon as they develop a new concept, without having to develop a full prototype, and without having to apply for consideration for a NASA-supplied environment aboard a parabolic test-flight. If a material existed that could be used in a terrestrial laboratory that mimics the behavior of real lunar regolith under lunar-gravity conditions, this material could provide a simple method for early stage flow/no-flow and other tests of material handling equipment.

In view of the foregoing, there is a need for improved techniques for providing materials which mimic the behavior of lunar or other extraterrestrial regoliths under reduced-gravity conditions, when they are used in tests on earth under terrestrial-gravity conditions.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram showing fixed quantities of two fine particulate powders being combined to create an exemplary batch of blended material, in accordance with an embodiment of the present invention;

FIGS. 2A and 2B illustrate two exemplary blending operations which may be used to effect the mixing of the original regolith simulant and the ultra-low-density additive powder, in accordance with an embodiment of the present invention. FIG. 2A is a schematic diagram showing a gentle blending process comprising a slowly rotated rectangular closed box partially filled with the two components of fine particulate to create one batch of a uniform blended simulant powder, and FIG. 2B is a schematic diagram of a gentle blending process comprising a slowly rocked rotating horizontal drum partially filled with the two components of fine particulate to create one batch of a uniform blended simulant powder

FIG. 3 is a schematic diagram of an exemplary screening or sieving process to separate coarse particles from fine particles, in accordance with an embodiment of the present invention; and

FIG. 4 is a flowchart illustrating an exemplary method for creating regolith simulant material comprising a very low-density fine particulate material additive blended with an original simulant material, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a blended regolith simulant material and method of making the material is presented.

In one embodiment a method includes steps for producing a lower bulk density blended regolith simulant material having gravity-driven flow properties that resemble those that an original regolith material would have under a reduced gravity of a target extraterrestrial body. Another embodiment further includes steps for separating out, and discarding, coarsest particles before blending. Yet another embodiment further includes steps for achieving an approximate bulk density of the blended regolith simulant material that is reduced from a bulk density of the original regolith simulant material by roughly a same factor as gravity on the target extraterrestrial body is reduced from the earth's surface gravity level.

In another embodiment a method includes the steps of blending a first part comprising a low-density fine particulate material additive with a second part comprising original regolith simulant material for producing a lower bulk density blended regolith simulant material having gravity-driven flow properties that resemble those that the original regolith material would have under a reduced gravity of a target extraterrestrial body. Another embodiment further includes the step of screening or sieving the original regolith simulant material for separating out, and discarding, coarsest particles before blending. Yet another embodiment further includes the step of adjusting a ratio of the first part to the second part for achieving an approximate bulk density of the blended regolith simulant material that is reduced from a bulk density of the original regolith simulant material by roughly a same factor as gravity on the target extraterrestrial body is reduced from the earth's surface gravity level. In still another embodiment a mass of particles separated out from the original regolith simulant material before blending with the low-density fine particulate material additive is at least, in part, dependent on the reduced gravity of the target extraterrestrial body. In another embodiment the low-density fine particulate material additive has a median particle size greater than a median particle size of the original regolith simulant material. In yet another embodiment the low-density fine particulate material additive has a median particle size greater than a coarse cut-off size of the screen or sieve used to remove the coarsest particles from the original regolith simulant material before blending. In another embodiment a pycnometer density of the low-density fine particulate material additive is less than 1200 kg per cubic meter for target extraterrestrial bodies which are a factor of approximately two lower in gravity than on earth. In yet another embodiment the pycnometer density of the low-density fine particulate material additive is less than 150 kg per cubic meter for target extraterrestrial bodies that have effective surface gravity as low as the moon, or lower. In still another embodiment the blended regolith simulant material comprises approximately one part by volume of the original regolith simulant material to N parts by volume of the low-density fine particulate material additive, where N is generally greater than one less than the ratio of the gravitational acceleration on the surface of the earth to the gravitational acceleration on the surface of the target extraterrestrial body and generally lies in the range obtained from the formula (F−1)≦N≦ρs(F−1)/(ρs−Fρb), where F is the ratio of gravitational acceleration on earth to that on the target extraterrestrial body, ρs is the bulk density of original regolith simulant material, and ρb is the bulk density of the low-density fine particulate additive. In another embodiment the low-density fine particulate material additive comprises solid organic polymer particles, screened or sieved to be in a size range smaller than 500 μm, and without a significant mass fraction smaller than 10 μm. In another embodiment the solid organic polymer particles are screened or sieved to be generally in the same size range as particles in the original regolith simulant material. In yet another embodiment the solid organic polymer particles have been agglomerated with a binder to create fine non-spherical particles prior to screening or sieving. In still another embodiment the agglomerated solid organic polymer particles are screened or sieved to be generally in the same size range as particles in the original regolith simulant material. In another embodiment the low-density fine particulate material additive comprises a rigid closed pore foam material, granulated and screened or sieved to be smaller than one millimeter without a significant mass fraction smaller than 10 μm. In yet another embodiment the rigid closed pore foam material is granulated and screened or sieved to be generally in the same size range as particles in the original regolith simulant material. In still another embodiment the low-density fine particulate material additive comprises an organic closed pore foam material in a size range below two millimeters. In another embodiment the organic closed pore foam material is granulated and screened or sieved to be generally in the same size range as particles in the original regolith simulant material without a significant mass fraction smaller than 10 μm. In yet another embodiment the low-density fine particulate material additive comprises an open-pore foam material. In still another embodiment the open-pore foam material is granulated and screened or sieved to be generally in the same size range as particles in the original regolith simulant material without a significant mass fraction smaller than 10 μm. In another embodiment the low-density fine particulate material additive comprises generally spherical, low density, hollow glass bubbles screened or sieved to be smaller than 300 μm without a significant mass fraction smaller than 10 μm. In yet another embodiment the hollow glass bubbles are screened or sieved to be generally in the same size range as the original regolith simulant material. In another embodiment the hollow glass bubbles have been agglomerated with a suitable binder to create non-spherical fine particulates, and screened or sieved so that the non-spherical fine particulates are smaller than one millimeter and without a significant mass fraction of particles smaller than 10 μm. In yet another embodiment the non-spherical fine particulates are screened or sieved so that they are generally in the same size range as the original regolith simulant material.

In another embodiment a method includes the steps of screening or sieving a low-density fine particulate material additive comprising generally spherical, low density, hollow glass bubbles to be smaller than 300 μm without a significant mass fraction smaller than 10 μm. The glass bubbles are agglomerated with a binder to create non-spherical fine particulates. The low-density fine particulate material additive is screened or sieved to be smaller than one millimeter, generally in the same size range as an original regolith simulant, and without a significant mass fraction of particles smaller than 10 μm. A first part comprising the low-density fine particulate material additive is blended with a second part comprising the original regolith simulant material for producing a lower bulk density blended regolith simulant material having gravity-driven flow properties that resemble those that the original regolith material would have under a reduced gravity of a target extraterrestrial body. Another embodiment further includes the step of screening or sieving the original regolith simulant material for separating out, and discarding, coarsest particles before blending. Yet another embodiment further includes the step of adjusting a ratio of the first part to the second part for achieving an approximate bulk density of the blended regolith simulant material that is reduced from a bulk density of the original regolith simulant material by roughly a same factor as gravity on the target extraterrestrial body is reduced from the earth's surface gravity level. In still another embodiment the blended regolith simulant material comprises approximately one part by volume of the original regolith simulant material to N parts by volume of the low-density fine particulate material additive, where N is generally greater than one less than the ratio of the gravitational acceleration on the surface of the earth to the gravitational acceleration on the surface of the target extraterrestrial body and generally lies in the range obtained from the formula (F−1)≦N≦ρs(F−1)/(ρs−Fρb), where F is the ratio of gravitational acceleration on earth to that on the target extraterrestrial body, ρs is the bulk density of original regolith simulant material, and ρb is the bulk density of the low-density fine particulate additive.

In another embodiment a blended regolith simulant material includes one part by volume of original regolith simulant material to N parts by volume of a low-density fine particulate material additive, where N is generally greater than one less than the ratio of the gravitational acceleration on the surface of the earth to the gravitational acceleration on the surface of a target extraterrestrial body and generally lies in the range obtained from the formula (F−1)≦N≦ρs(F−1)/(ρs−Fρb), where F is the ratio of gravitational acceleration on earth to that on the target extraterrestrial body, ρs is the bulk density of original regolith simulant material, and ρb is the bulk density of the low-density fine particulate additive. In another embodiment the low-density fine particulate material additive comprises at least one element chosen from a list comprised of solid organic polymer particles, rigid closed pore foam material, rigid closed pore foam material, open-pore foam material, and generally spherical, low density, hollow glass bubbles.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Low density hollow glass bubbles are often added to industrial liquids to effectively reduce the bulk density of the blended fluid. They are used to reduce the density of drilling ‘mud’ in deep oil well-drilling operations, for example, in order to facilitate pumping. They are used to ‘expand’ or extend the surface area covered by paint, and as an additive to cements as they are being mixed with water and aggregate to create a low density concrete—for light-weight concrete roofing tiles, among other applications. In this invention ultra-low density fine particulates are blended with dry powders to create new blended powders with reduced bulk densities, while maintaining other physical properties quite similar to those of the original powder.

Preferred embodiments of the present invention provide a method for creating soil-like materials that mimic the effects of being in a reduced gravity environment. In preferred embodiments an appropriately selected ultra-low density fine particulate material is blended with the fine-fraction of a regolith simulant to create a new low-density surrogate regolith simulant which has a reduced gravity driving force because of its reduced density. The new low-density blended surrogate simulants, thus created according to preferred embodiments, mimic many of the effects of being under low-gravity, such as, but not limited to, being difficult to pour or to initiate flow when being transferred from one container to another and requiring larger size openings for flow to occur through funnels or out of hoppers. In preferred embodiments, the new blended simulants can have nearly the same geotechnical/mechanical deformation and cohesive-strength behavior as unblended regolith simulants, yet with a significantly lower bulk density. Utilization of these low-gravity-mimicking simulants according to preferred embodiments enable researchers to test equipment designs for flow versus no-flow conditions without utilizing rocket launches, drop towers or parabolic aircraft flights.

Preferred embodiments of the present invention provide methods to create new low-density surrogate regolith simulant materials that can mimic several aspects of gravity-induced flow behavior of in-situ regolith in equipment planned for missions to the moon, Mars, and other solar system bodies. In preferred embodiments, this reduced-gravity simulant material is well suited for testing flow/no-flow conditions such as, but not limited to, emptying an excavator bucket, flow out of a hopper or funnel, or flow after opening any regolith flow-control valve in in-situ resource utilization processing equipment. The new simulant material according to preferred embodiments is less well suited for mimicking the flow behavior of regolith in situations where the regolith inertia may play a significant role; however, alternate embodiments may be developed that more accurately mimic this behavior.

With the addition of preferred embodiments of the present invention, a new criterion for evaluating the fidelity (or accuracy) of a regolith simulant is created, based on the degree of accuracy with which the simulant is able to mimic the effects of reduced gravity. Various embodiments of the present invention achieve different degrees of fidelity in mimicking the effects of reduced gravity. Some embodiments are more friable than true regolith, and thus are only effective under low stress conditions. Other embodiments may exhibit slightly lower fidelity in terms of accuracy of mimicking reduced gravity effects, yet are more robust to higher stress levels, and thus, able to simulate reduced gravity deformation and flow behavior under higher loading conditions than the more friable embodiments. The low-gravity emulating blended regolith simulants created according to preferred embodiments offer an inexpensive method to perform terrestrial laboratory tests indicating whether solids will flow or not under reduced gravity. In preferred embodiments, these reduced gravity mimicking simulants may be used by various different parties including, but not limited to, NASA researchers, various nations' or international collaborative space programs, and/or future commercial ventures, for designing equipment for use on manned or robotic missions on the moon, Mars or other solar system bodies.

Some embodiments of the present invention are directed to methods used to achieve different levels of fidelity in mimicking the effects of reduced gravity, while also maintaining a high fidelity in reproducing the physical or geotechnical properties of simulated regolith. Preferred embodiments sacrifice fidelity of chemical and mineral composition in order to maintain high fidelity in physical behavior and also attain the new capability of mimicking the effects of reduced gravity on the deformation and flow behavior of the simulated materials. The focus of most of the discussion of geotechnical properties in this description emphasizes lunar regolith because that is a material about which much scientific data has been gathered. The general concepts and the specific methods of preferred embodiments apply equally well, however, to simulants of regolith for any solar system body that has a smaller surface gravity than the earth such as, but not limited to, Mars, the moons of any of the larger planets, Kuiper-belt objects, asteroids, comets, etc. The cohesive strength of fine particulate powders is usually controlled by the properties of the finest 20% of the material in the powder. The shear-strength is also strongly affected by the finest size-fraction; however, the shear resistance can also be affected by large irregularly shaped particles in the distribution of particles in the powder. Some embodiments of the present invention directly address methods to maintain high geotechnical property fidelity, even when the shear strength is significantly affected by large non-spherical particles similar to agglutinates found in some lunar regoliths.

Lunar regolith has a much wider size distribution than most naturally occurring fine particulate soils, or sands found on earth. Terrestrially, transport by wind and water tend to segregate particulates and deposit like-sized particles in similar locations. The moon lacks these transport processes. Water and air, also provide chemical source materials which both dissolve fine particulates and bond particles together. Both of these processes tend to reduce the range of particle sizes in naturally occurring terrestrial soils or sand deposits. Again, these processes do not exist on the moon, thus large quantities of very fine particulates, created by micrometeorite impacts, are found in lunar regolith almost everywhere on the lunar surface. The cohesive strength and shear strength of fine silty soils with wide size distributions, is often controlled, or very strongly influenced by, the finest particulates in the soil. This is especially true if the volume fraction of very fine particles is sufficient to fill the interstitial space between the largest particles, so that the largest particles seldom contact each other but rather are ‘coated’ by the fines. Preferred embodiments of the present invention take advantage of the dominance of the cohesive effects of fine particulates in regolith, especially those particles smaller than 20 μm.

Under lunar gravity the cohesive nature of powders start to have an influence on the bulk deformation and flow properties of granular materials at much larger particle sizes than is typical of terrestrial powder flow operations. All materials exhibit surface energy van der Waals forces that are very short range, yet come into play once surfaces are ‘touching.’ These van der Waals forces are due to the dispersive and polar surface energies inherent at material boundaries. Terrestrially, dry powders with mass-median particle sizes larger than around 100 to 200 μm, seldom exhibit strong ‘cohesive’ powder behavior, and such powders are usually described as ‘free flowing.’ As particle size decreases, however, the amount of surface area per unit mass increases, and surface-energy forces have a greater influence on bulk powder flow characteristics. The large proportion of very fine particulates in typical regolith, combined with reduced gravity and potentially reactive surface chemistry, contribute to physical characteristics which are apt to differ substantially from those exhibited by material in typical terrestrial resource recovery processes.

Body forces due to gravity, and thus lithostatic or overburden loads, are reduced by about a factor of six on the moon. Most terrestrial granular material handling processes utilize gravity to initiate flow into feeders, onto conveyors, or out of buckets or hoppers. For the same size equipment, the body force per unit area at equipment openings on the moon are reduced by a factor about equal to the reduction in gravity (i.e., by about a factor of six) over what is typical on earth. In order to initiate flow, due solely to lunar gravity, the size of equipment openings need to be scaled to larger dimensions. If lunar resource transport and handling equipment openings are not scaled to larger sizes than is typical for terrestrial designs, it is probably necessary to utilize alternative means of initiating and/or maintaining flow into, out of, or within various processing stages, such as, but not limited to, pneumatic, vibration, centrifugal forces, or mechanical forces.

It is increasingly being recognized by the geotechnical community that decreasing gravity decreases the major driving force acting on materials in many processing operations, thus causing assemblies of particles (i.e., powders) to appear to be more cohesive in their bulk behavior than they would on earth [e.g., Brucks, 2008; Mueller, 2009; Walton, 2007]. In laboratory studies of powder flows in rotating drums under different centrifuging conditions, it was observed that reductions in g-level by a factor of four could change the flow behavior of a fine powder from that of a typical free-flowing powder with a single angle of repose, to that of a very cohesive, avalanching, and clumping powder [Walton, 2007]. Preferred embodiments of the present invention produce a similar reduced-driving-force effect by reducing the bulk density of the simulant powder, thus decreasing the gravity driving forces attempting to cause powder to flow or deform. The blended, reduced-density, simulants created using preferred embodiments ‘behave’ like more cohesive powders, even though their cohesive strength and shear strength remain nearly the same as those of the original density materials.

If the bulk density of a regolith simulant can be reduced by a factor of 6, the force of gravity acting on each given volume of that reduced-density material is a factor of 6 less than in the original material. Typical lunar regolith and simulant powders created to represent lunar regolith, such as, but not limited to, those listed in Table 1, exhibit a bulk density of around 1500 kg per cubic meter when simply poured into a container, without any additional compaction. A number of very low-density fine-particulate materials exist which could be blended with a simulant in preferred embodiments to create a blended fine powder that has a density significantly lower than the original simulant. In preferred embodiments, by selecting a low-density particulate that does not have a significant quantity of very fine material (e.g., very little material smaller than 20 μm), the low-density material can be blended with a lunar regolith simulant with minimal change to the cohesive strength of the simulant material. The minimal change in powder cohesion in preferred embodiments occurs because the fines in the original regolith simulant tend to coat the larger particles of the blended low-density additive, so that most of the large low-density particles do not contact each other directly in the blend, but make contact through a coating of fine regolith simulant dust coating the larger particles.

In one preferred embodiment, using low density glass bubbles with a bulk density of around 75 kg/m³ (i.e., glass bubbles with a pycnometer ‘grain’ density of around 125 kg/m³, and a solids-packing fraction of about 0.6) as the low-density additive, and the fine-fraction of a lunar simulant as the material to blend with the glass bubbles, it is possible to estimate the quantity of glass bubbles that is required to create a blend with a density that is one sixth of the original simulant density of around 1500 kg/m³ to attain a target density of around 250 kg/m³. In this embodiment the following formula is used to determine the ratio of fine-fraction of original stimulant to low-density additive needed to produce the desired reduced-gravity effects. If each material in the blend exhibits the same bulk density as in its respective unblended state, a mixture of 1 part by volume of fine-fraction of original regolith simulant to Nparts by volume low-density additive, where N is given by,

N≈ρₛ(F−1)/(ρₛ−Fρ_{b})

where F is the ratio of gravitational acceleration on earth to that on the moon or other solar system body, ρₛ is the bulk density of original simulant as poured, and ρ_{b} is the bulk density of the low-density additive (e.g., glass bubbles), produces a blend with a density that is a factor 1/F smaller than the original density of the simulant. Using values of ρₛ=1500, and ρ_{b}=75, and F=6, to represent the reduced gravity of the moon, this formula gives a value of N≈7.14 as the volume ratio for blending low density glass bubbles with regolith simulant in order to achieve a blend with a bulk density around 250 kg/m³. In practice, the volume blend ratio can be somewhat smaller than the value given by the above formula and the resulting blend can still have a density that approximates the preferred target value, since the blended material is often less compacted upon pouring into a container, giving it a lower density, and thus is under lower overburden loading than material of higher density. Typical very low-density glass bubbles, without a significant quantity of fines below 20 μm often pack at a volume fraction of around 60% of their pycnometer density. Once they are blended with a material containing very small dust particulates according to preferred embodiments, the glass bubbles become coated with the fines and the blend exhibits more cohesion than the larger glass bubbles alone, and thus the blend tends to resist packing as efficiently as the glass bubbles alone. The net result is that the blended material from preferred embodiments usually exhibits a density somewhat lower than would be expected from a linear volume addition rule, as was used to obtain the mixture ratio formula above. Blends with a volume ratio as low as N≈(F−1) are found to have a bulk density close to (1/F)ρₛ, especially if the simulant material being blended with the low-density additive has been pre-screened to remove the coarsest size fraction before blending, which may be done in some embodiments of the present invention.

The tendency for cohesive powders to resist compaction is well known. The pharmaceutical industry routinely deals with fine cohesive powders and often characterizes how cohesive a powder is by its Housner ratio, that is, the ratio of the density after being ‘tapped’ repeatedly to compact it, to its initial sifted density [Abdullah, 1999; Housner, 1967]. Such tapped-density tests serve as index tests to classify the cohesiveness of powders. The blended powders produced by preferred embodiments of the present invention exhibit a higher Housner ratio than the original simulant materials, thus they are classified by such index tests as being more cohesive than the original simulant powder. In reality, the compaction resistance, the shear strength and the cohesive strength of the blends in preferred embodiments, is not usually increased any significant amount by blending with most ultra-low density particulates which do not contain a significant quantity of material smaller than 20 μm. It is only the Housner test, which is an index test and not a true material property test, that indicates an increase in cohesiveness. Typical geotechnical tests, such as, but not limited to, shear-cell tests or triaxial compaction tests, do not show a significant increase in cohesiveness or shear-strength of low-density blended powders according to preferred embodiments over those of the original simulant powders, although results may vary depending on the selection of low-density additive used for the blend.

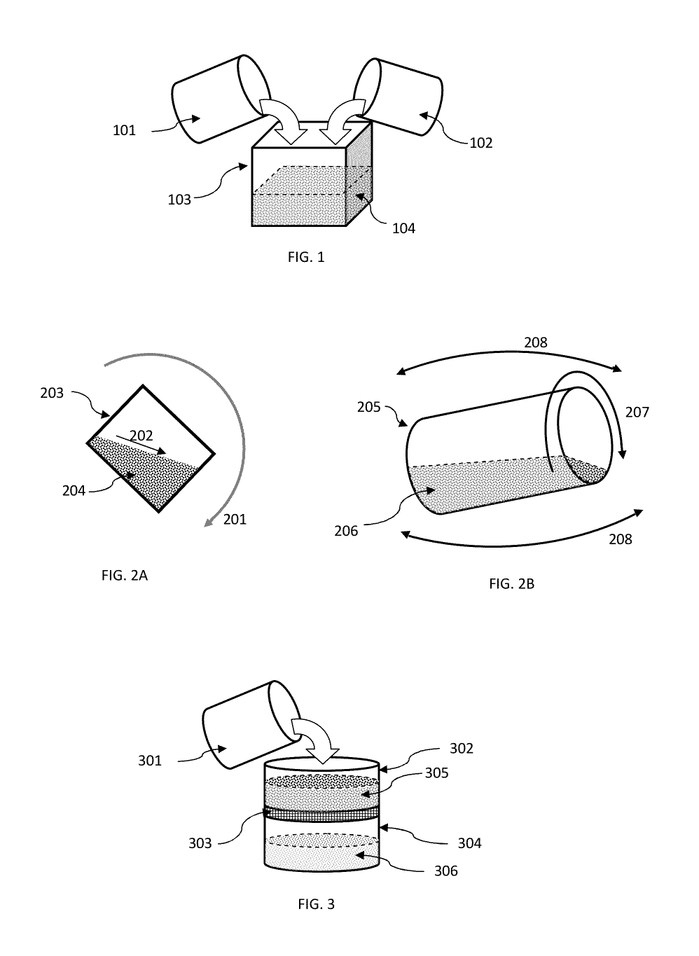

Certain embodiments of the present invention utilize a regolith simulant, without modification, blended with an ultra-low density additive to achieve a new low-density blended surrogate simulant that mimics the effects of being at reduced gravity. An example of the process to create such a blend is illustrated in FIG. 1. FIG. 1 is a schematic diagram showing fixed quantities of two fine particulate powders being combined to create an exemplary batch of blended material, in accordance with an embodiment of the present invention. In the present embodiment, the entire pre-measured, fixed quantity of a regolith simulant in a container 101 is poured into a blender 103. Likewise a different pre-measured quantity of an ultra-low-density additive powder in a container 102 is poured into blender 103. Once containers 101 and 102 are emptied into batch blender 103, batch blender 103 containing a combination 104 of the powders is closed and rotated, vibrated or oscillated, depending on the specific operation of blender 103, until a uniform blend of the powders originally in containers 101 and 102 is obtained.

FIGS. 2A and 2B illustrate two exemplary blending operations which may be used to effect the mixing of the original regolith simulant and the ultra-low-density additive powder, in accordance with an embodiment of the present invention. FIG. 2A is a schematic diagram showing a gentle blending process comprising a slowly rotated rectangular blending box 203 partially filled with the two components of fine particulate to create one batch of a uniform blended simulant powder, and FIG. 2B is a schematic diagram of a gentle blending process comprising a slowly rocked rotating horizontal drum blender 205 partially filled with the two components of fine particulate to create one batch of a uniform blended simulant powder. Blender 103, shown by way of example in FIG. 1, could be blending box 203 in FIG. 2A or drum blender 205 in FIG. 2B. In alternate embodiments various different types of blenders or blending methods may be used. Referring to FIG. 2A, as rectangular blending box 203 rotates slowly in a clockwise direction according to an arrow 201, the top surface of a powder 204 to be blended flows in the direction according to an arrow 202, resulting in a gradual blending of powder 204 contained in box 203 over many complete rotations of blending box 203. Referring to FIG. 2B, the gravity-flow of an oscillating-axis rotating-drum blender 205 is another apparatus that may be used to effect the blending of a powder 206. Drum blender 205 rotates about a longitudinal axis and gently rocks back and forth about a lateral axis to create the gravity-flow.

The precise method for blending is not a crucial aspect of preferred embodiments of the present invention and the methods shown by way of example in FIG. 2A and FIG. 2B are merely suggestions of two types of well known gentle gravity-flow blending apparatuses which are suitable for mixing dry solid powders used in preferred embodiments of the present invention. Referring to FIG. 2A arrows 201 and 202 indicate the direction of rotation of rectangular blending box 203 and the surface material flow inside box 203 as it rotates, respectively. Referring to FIG. 2B arrows 207 and 208 indicate the direction of rotation of partially filled, nearly horizontal drum blender 205 and the direction of the slow axial oscillations of drum blender 205, respectively. Those skilled in the art, in light of the present teachings, will readily recognize that there are many other potential mixing or blending processes which can be used to achieve a uniform blend of the two powders including, without limitation, including ‘V’-blenders, rotating drum blenders, hoppers with pneumatic recirculation-loops, stationary ribbon blenders, dual-axis rotating opposing-cone blenders, or any of a whole host of other gentle blending processes. Generally, gentle blending processes are preferred over more aggressive, or high-speed, processes in order to avoid breaking the particles. High shear blenders, with high-speed impeller blades, are probably not as well suited for blending the powders of interest, since the high-speed blades may cause particle breakage, and thus modify the physical properties of the powder. Typical regolith simulants, such as, but not limited to, those listed in TABLE 1, do not exhibit particularly high cohesion and can usually be blended adequately, utilizing gravity flow, in slowly rotated or oscillated containers similar to those illustrated, by way of example, in FIG. 2A or FIG. 2B. Once blended, the powders may have a slight tendency to segregate upon shearing or pouring; however, because the fines from the simulant powder typically adhere strongly to the surfaces of the larger low-density additive particles, such segregation is usually relatively minor. The type of segregation occasionally seen with the blended simulant powders usually involves a small quantity of very fine additive powder fluidized by the interstitial air during pouring or transfer operations. A small quantity of airborne fine sometimes deposits a light ‘dusting’ on top of the poured material. If the blended powder is used under partial vacuum conditions (to better simulate a lunar, or other planetary environment) then this fluidization and dusting does not occur.

In preferred embodiments the process for creating a blended simulant for mimicking reduced gravity conditions may include the removal of a coarse size fraction of the original simulant before blending with a low-density additive In the process of adding a large quantity of ultra-low density additive material to a regolith simulant, it is possible that the quantity of additive may be so large that it changes the physical behavior of the simulant so much that the blend no longer maintains high fidelity in reproducing the physical and geotechnical properties of the target regolith. One method to minimize this reduction in physical-property fidelity is to use the larger particle size ultra-low-density additive primarily as a replacement for the coarsest material in the original simulant. The bulk powder physical property effects of the coarsest size fraction are created primarily by size and shape distribution of the large particles in the regolith and are less dependent on the surface chemistry and cohesive surface forces. The cohesive strength of a bulk powder, on the other hand, is often controlled by the surface energy, surface area, and surface morphology of the finest particles in the powder. For this reason, the fidelity of the blended powder, as represented by the cohesion and shear properties of the target regolith, is usually higher if the finest particles in the blend still represent approximately the same volume-fraction after blending as they did in the original simulant. Also, it is possible to create ultra-low-density additives with particle sizes and shapes that are similar to the sizes and shapes of the removed coarse size fraction of the original simulant. If the original coarse size fraction is replaced with an ultra-low-density coarse size fraction with a similar size and shape distribution to the material removed, the probability of maintaining high fidelity in the physical and geotechnical properties of the blend increases. The surface-chemistry and surface-energy of the coarse fraction does not play a great role in the geotechnical properties of the overall powder, thus changes in the chemical composition of the coarse size fraction generally have a minimal effect on those important properties. Physical screening of the original regolith simulant is one way to separate the coarse particles from the fine particles. However, other separation methods may be used such as, but not limited to, an elutriating fluidized bed (with a vertical superficial gas velocity sufficient to carry particles smaller than a desired cutoff threshold away in the gas stream to be deposited on a filter, while leaving the coarse material behind), cyclone separators, cascade impactors, centrifugal concentrators, or shaking tables. Wet separators could also be used as long as none of the materials involved would be irreparably damaged or modified by contact with a liquid. Examples of wet size segregation methods include, but are not limited to, hydro-cyclones, Reichart cones and spiral concentrators.

FIG. 3 is a schematic diagram of an exemplary screening or sieving process to separate coarse particles from fine particles, in accordance with an embodiment of the present invention. In the present embodiment, a typical sieving or screening apparatus comprises a stacked set of containers 302 and 304, separated by a precise sizing screen 303. Commercially available sizing screen stacks are usually set on an oscillating or vibratory stand, not shown, to assist in achieving flow and separation of material into different size fractions. An original simulant material in a container 301 is poured into upper container 302 of the screening apparatus. Coarsest material 305 does not pass through sizing screen 303 and remains in upper container 302. Finer material 306, which is smaller than the openings in sizing screen 303, passes down through screen 303 and deposits in lower container 304.

For embodiments of the present invention that remove the coarsest size fraction before blending, the measurement of the mass or volume of simulant powder for blending with the ultra-low-density additive is done after the separation and removal of the coarse size fraction. These embodiments use the fine fraction as the feedstock, or regolith component for a blending process. The remainder of the process is the same as for a simple blend of simulant and low-density additive.

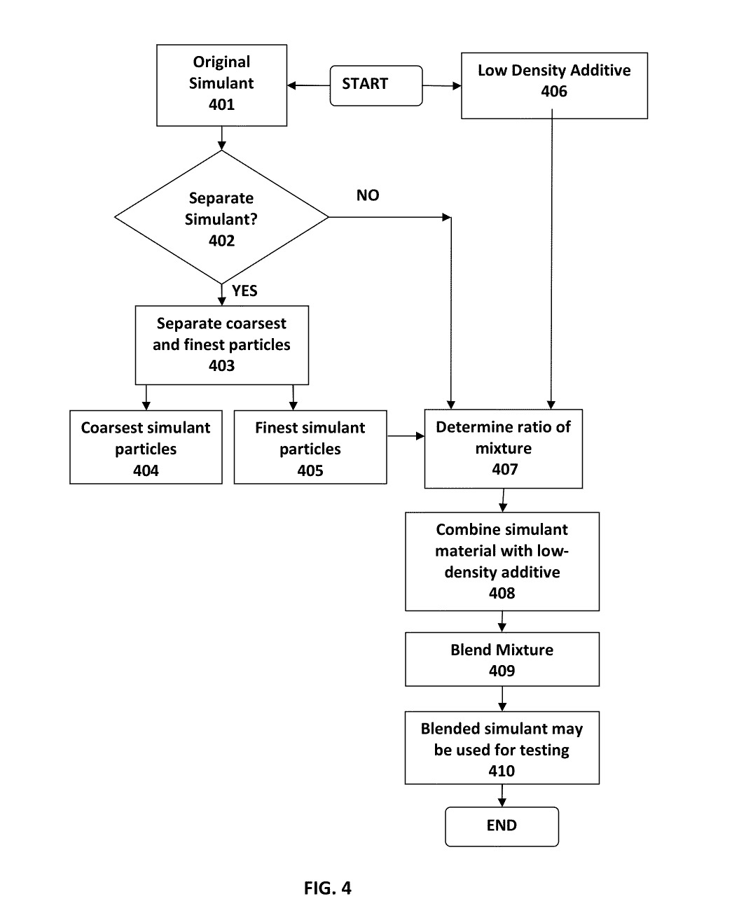

FIG. 4 is a flowchart illustrating an exemplary method for creating regolith simulant material comprising a very low-density fine particulate material additive blended with an original simulant material, in accordance with an embodiment of the present invention. Herein, the term agglomerate refers to enlarging particles by having them processed so that some stick together in small clumps, or aggregates, along with some type of binder or glue that hold the aggregates together after processing, and the term granulate refers to chopping or breaking up the particles to make them smaller.

The method begins with the original regolith simulant 401 and the low density additive 406 that is going to be blended with the original simulant, or the fine particles from that simulant, to produce the new low-gravity emulating simulant. At step 402 it is determined if the original regolith simulant material 401 should be screened to separate out and discard the coarsest particles 404 before blending the remaining fine fraction of the original regolith simulant material 405 with the very low-density fine particulate additive material 406. If so, the original regolith simulant is screened or sieved in step 403. The method of separating the coarsest particles from the original regolith simulant may be similar to the method shown by way of example in FIG. 3, or different methods may be used, as previously described. Depending on the desired properties for the final blended simulant material, the size of the particles removed from the original regolith simulant may vary. Also, for blends needing a larger volume fraction of ultra-low density additive in order to come close to the target bulk density reduction in the final blended powder, it may be useful to remove a larger portion of the coarse material in the original simulant before blending with the low density additive powder. For example, without limitation, in one example, at least the largest 25% mass fraction is removed from the original regolith simulant material before blending with the very low-density fine particulate additive material so the material being blended with the low-density additive represents only the finest 75%, or less, of the original regolith simulant material. In other non-limiting examples, at least the largest 50% mass fraction or at least the largest 75% mass fraction may be removed from the original regolith simulant material before blending. Target applications aimed at greater reductions in density (i.e., for smaller extra-terrestrial bodies, like the moon) may require a greater portion of the coarse material to be removed before blending, in order for the resulting blended powder to maintain reasonable fidelity in matching the strength and cohesion properties of the target regolith.

Once the original regolith simulant is screened or sieved, or if the original regolith simulant material is not to be screened or sieved in step 403, the method continues to step 407. In step 407, the mixture ratio of the low-density fine particulate additive material 406 to original regolith simulant 401 or retained fines from the original regolith simulant 405 is determined so that the approximate bulk density of the new blended material is reduced from the bulk density of the original regolith simulant by the roughly the same factor as gravity on the target moon or planetary object is reduced from the earth's surface gravity level. In the present embodiment the blend preferably comprises approximately one part by volume of the original regolith simulant or the retained fine fraction of the original regolith simulant to N parts by volume of the very low density fine particulate additive, where N is generally obtained from the formula

(F−1)≦N≦ρₛ(F−1)/(ρₛ−Fρ_{b})

where F is the ratio of gravitational acceleration on earth to that on the moon or planet, ρₛ is the bulk density of original simulant (as poured), and ρ_{b} is the bulk density of the low-density additive. For the earth's moon, F is approximately 6, and for Mars, F is approximately 2.6.

It should be noted that, if the preferred blend ratio from the above formula has a value of N significantly greater than 5, then the fidelity of maintaining geotechnical (e.g. shear strength and cohesion) properties in the blend which are close to the original values, may not be easily met, since the blend would contain less than 20% of the original material, by volume. In such cases, a compromise between achieving high fidelity in mimicking reduced gravity and maintaining reasonable fidelity in geotechnical can be made. Generally blends created with values of N greater than 10 are likely to have significantly modified geotechnical properties, while those with values of N less than 5 can more accurately maintain the original cohesive strength and shear strength of the original simulant.

In step 408, the original regolith simulant 401 or the retained portion of the original regolith simulant 405 is combined with the low-density fine particulate additive material 406 in the ratio determined in step 407. In step 409 the two material are blended together to form a nearly homogeneous mixture. Various different blending methods may be used including, but not limited to, those shown by way of example in FIGS. 2A and 2B, V-blenders, rotating blenders, ribbon blenders, recirculating blenders, etc. The low-density fine particulate additive material preferably has a median particle size greater than the median particle size of the original regolith simulant material or greater than the coarse cut-off size of the screen or sieve used to remove coarse material from the original regolith simulant material before blending. The density of the particulate additive material may vary depending on factors such as, but not limited to the type of simulant material being used and the desired properties of the final blended simulant. For example, without limitation, the pycnometer density of the additive fine particulate material may be less than 1200 kg per cubic meter, less than 600 kg per cubic meter, less than 300 kg per cubic meter, less than 150 kg per cubic meter, or other suitable densities. Generally lower-density additive powders are more fragile or friable than potential higher-density additives. For example, solid polystyrene micro-spheres, with pycnometer densities ˜1040 kg/m³, are quite resistant to permanent deformation or crushing, while closed pore organic foams like expanded polypropylene beads are quite soft and compress easily. Similarly, powders comprised of rigid aerogels, while having a very low bulk density, may be quite friable, and thus only suitable for tests under low stress conditions. Once the original regolith simulant 401 or the retained portion of the original regolith simulant 405 and the low-density fine particulate additive material 406 are blended, the blended simulant material may be used for testing in step 410.

A variety of low-density particulate materials can be utilized. For example, without limitation, expanded polypropylene beads such as, but not limited to, JSP ARPRO 5920 beads with a density of 200 kg/m̂3 and an ellipsoidal size approximately 1 by 2 mm may be utilized; however, this material is not likely to function well under vacuum conditions, which may be desired. Plastic microspheres, which are compressible, resilient, hollow particles and can have specific gravities as low as 0.025, could be used as the ultra-low density additive material. Fine, hollow glass bubbles, such as 3M Company's K or S series bubbles have size distributions that are of the same order as lunar or Martian regoliths, except without the finest fraction (e.g., below 20 μm). Thus, in another non-limiting example, a blend of small glass bubbles (e.g., characteristic size around 50 μm) with the fine fraction of a lunar simulant can create a low-density blended material which retains a cohesive strength like the original simulant, yet has a significantly reduced bulk density.

In one embodiment the low-density fine particulate material additive blended with the original simulant material or the retained fine fraction of the original simulant material is comprised of solid organic polymer particles, such as, but not limited to, polyethylene microspheres. These polymer particles may have various different sizes depending on factors such as, but not limited to, the type of original simulant material being used or the desired characteristics of the final blended simulant material. For example, without limitation, the polymer particles may be sieved or screened to be in a size range smaller than 500 μm without a significant mass fraction smaller than 10 μm, sieved or screened to be generally within the same size range as the regolith simulant without a significant mass fraction smaller than 10 μm, agglomerated with a suitable binder to create fine non-spherical particles sieved or screened to be in a size range smaller than 500 μm without a significant mass fraction smaller than 10 μm, agglomerated with a binder to create fine non-spherical particles sieved or screened to be generally within the same size range as the regolith simulant without a significant mass fraction smaller than 10 μm, etc.

In another embodiment, the low-density fine particulate material additive blended with the original simulant material or the retained fine fraction of the original simulant material is comprised of a closed pore organic foam material such as, but not limited to, expanded polypropylene beads. This closed pore foam material may have particles of various different sizes depending on factors such as, but not limited to, the type of original simulant material being used or the desired characteristics of the final blended simulant material. For example, without limitation, the particles may be sieved to obtain a size range below two millimeters, or they may be granulated or chopped and then sieved or screened to be smaller than one millimeter without a significant mass fraction smaller than 10 μm, or granulated and then sieved or screened to be in a size range generally within the same size range as the regolith simulant without a significant mass fraction smaller than 10 μm, etc.

In another embodiment, the low-density fine particulate material additive blended with the original simulant material or the retained fine fraction of the original simulant material is comprised of an open-pore foam material such as, but not limited to, a silica aerogel. This open-pore foam material may be granulated and sieved or screened to be generally in the same size range as the original regolith simulant without a significant mass fraction smaller than 10 μm or other appropriate size, or may be various other suitable sizes.

In another embodiment, the low-density fine particulate material additive blended with the original simulant material or the retained fine fraction of the original simulant material is comprised of hollow thermoplastic microspheres. These plastic microspheres may be sieved or screened to be generally in the same size range as the original regolith simulant without a significant mass fraction smaller than 10 μm or other appropriate size, or may be various other suitable sizes.

In yet another embodiment, the low-density fine particulate material additive blended with the original simulant material or the retained fine fraction of the original simulant material is comprised of mostly spherical, low density, hollow glass bubbles. These hollow glass bubbles can be selected to have various different sizes depending on factors such as, but not limited to, the type of original simulant material being used or the desired characteristics of the final blended simulant material. For example, without limitation, the glass bubbles may be sieved or screened to be smaller than 300 μm without a significant mass fraction smaller than 10 μm, sieved or screened to be generally in the same size range as the original regolith simulant without a significant mass fraction smaller than 10 μm, or they may be agglomerated with a suitable binder such as water glass (a sodium silicate solution in water) to create small aggregated non-spherical fine particulates and screened or sieved so that the glass bubble aggregates are smaller than one millimeter and without a significant mass fraction of particles smaller than 10 μm, or they could be agglomerated with a suitable binder, such as water glass, to create non-spherical fine particulates and then screened or sieved so that the glass bubble aggregates are generally in the same size range as the original regolith simulant except without a significant mass fraction smaller than 10 μm, etc.

In a non-limiting example of testing done on a low-density, blended simulant material, simple funnel flow tests using a mixture of JSC-1AF fine-fraction lunar regolith simulant, screened to retain only particles smaller than 30 μm and blended with ultra-low density glass bubbles with a bulk density of approximately 75 kg/m³ demonstrated that the low-density blended simulant requires larger openings to initiate flow than did the original simulant without the density-reducing glass bubbles. This same low-density blended simulant formed a ‘rathole’ during flow through a nearly 3 cm diameter opening out of a 60-degree cone-angle hopper, which was not observed with the full-size-distribution JSC-1A simulant material, yet is typical of cohesive powders. Qualitative observations of JSC-1A simulant and the blend of JSC-1AF with glass bubbles in the same flow tests of partially filled, slowly rotated, horizontal drums showed that the blended simulant exhibited larger clumps and higher vertical ‘cliffs’ on the top surface than were observed with the original JSC-1A simulant. The occurrence of such cliffs and/or clumps in rotating drum flows is a feature typically associated with cohesive powders. Thus, the blended material (i.e., JSC-1AF and glass bubbles) appeared to be more cohesive than the original JSC-1A simulant in this index test of flow behavior.

In order to determine the proper mixture ratios and to verify that the low-density, blended regolith simulant material provides the expected behavior, a series of parabolic flight flow calibration tests may be performed on each new lunar or Martian regolith simulant material developed. This series of simple flow/no-flow tests, through circular holes, through funnels with various sized openings, and out of inverted cylindrical and rectangular containers can serve to establish minimum hole sizes, funnel sizes and container sizes through or out-of which the simulant freely flows under reduced gravity conditions. Once this series of parabolic flight flow calibration tests is performed on a new regolith simulant, a low-density blend of ultra-low-density particulate with the fine-fraction of the new regolith simulant is created, which should reproduce the same flow/no-flow behavior under terrestrial gravity conditions that the original simulant exhibited under low-gravity. Adjustments to the mixture ratios and/or the selection of low-density material for blending can be made until there is agreement between the flow/no-flow behavior of the low-density blended simulant at one-g and the original simulant under Lunar-g or Martian-g conditions. Verification that a series of flow/no-flow tests can be reproduced under terrestrial gravity conditions with the low-density blend will allow the low-density blended simulant to be used with some confidence that it is faithfully providing an index test of flow/no-flow behavior under Lunar, Martian or other reduced gravity conditions. Once the flow/no-flow calibration data is available for a specific regolith simulant, specific recipes for ‘calibrated’ blends of that simulant's fines and glass bubbles or other low-density particulate can be determined which most closely reproduce the flow/no-flow test results.

Those skilled in the art will readily recognize, in accordance with the teachings of the present invention, that any of the foregoing steps and/or composition components may be suitably replaced, reordered, removed and additional steps and/or composition components may be inserted depending upon the needs of the particular application.

In general any low density fine particulate powder additive which produces a blended material with a bulk density that is reduced by at least a factor of (2/F), where F is the ratio of gravitational acceleration on earth to the gravitational acceleration on the target extraterrestrial body, will substantially achieve the goal of the invention. That is, a reduction in bulk density by a factor of (2/F) will mimic many of the flow, no/flow, conditions of being at reduced gravity, without having to actually produce low-gravity conditions. If the change in bulk density can be made closer to a factor of (1/F) by adjusting the blend ratios or by using a lower density additive powder, then the fidelity of the low-gravity mimicking aspects of the new blend will be improved; however, even if the density ratio does not fully meet the target (1/F) value, the new blended powder described by this invention will better represent the gravity-flow behavior of the simulant under reduced gravity conditions, than would be obtained using the original unblended simulant alone.

Having fully described at least one embodiment of the present invention, other equivalent or alternative methods of providing low-density, blended regolith simulant materials according to the present invention will be apparent to those skilled in the art. The invention has been described above by way of illustration, and the specific embodiments disclosed are not intended to limit the invention to the particular forms disclosed. For example, the particular implementation of the blended simulant may vary depending upon the particular type of fine particulate material used. The fine particulate material described in the foregoing were directed to regolith simulant implementations; however, similar techniques are to use various different types of material as the fine particulate material such as, but not limited to, crushed rocks, cement powder, other powdered minerals, or elemental iron powder (as might be an appropriate simulant for the surface material of an iron based asteroid), etc. Non-regolith simulant implementations of the present invention are contemplated as within the scope of the present invention.

The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method comprising:
steps for producing a lower bulk density blended regolith simulant material having gravity-driven flow properties that resemble those that an original regolith material would have under a reduced gravity of a target extraterrestrial body.

2. The method as recited in claim 1, further comprising steps for separating out, and discarding, coarsest particles before blending.

3. The method as recited in claim 1, further comprising steps for achieving an approximate bulk density of the blended regolith simulant material that is reduced from a bulk density of the original regolith simulant material by roughly a same factor as gravity on the target extraterrestrial body is reduced from the earth's surface gravity level.

4. A method comprising the steps of:
blending a first part comprising a low-density fine particulate material additive with a second part comprising original regolith simulant material for producing a lower bulk density blended regolith simulant material having gravity-driven flow properties that resemble those that the original regolith material would have under a reduced gravity of a target extraterrestrial body.

5. The method as recited in claim 4, further comprising the step of screening or sieving the original regolith simulant material for separating out, and discarding, coarsest particles before blending.

6. The method as recited in claim 4, further comprising the step of adjusting a ratio of the first part to the second part for achieving an approximate bulk density of the blended regolith simulant material that is reduced from a bulk density of the original regolith simulant material by roughly a same factor as gravity on the target extraterrestrial body is reduced from the earth's surface gravity level.

7. The method as recited in claim 5, wherein a mass of particles separated out from the original regolith simulant material before blending with the low-density fine particulate material additive is at least, in part, dependent on the reduced gravity of the target extraterrestrial body.

8. The method as recited in claim 4, wherein the low-density fine particulate material additive has a median particle size greater than a median particle size of the original regolith simulant material.

9. The method as recited in claim 5, wherein the low-density fine particulate material additive has a median particle size greater than a coarse cut-off size of the screen or sieve used to remove the coarsest particles from the original regolith simulant material before blending.

10. The method as recited in claim 4, wherein a pycnometer density of the low-density fine particulate material additive is less than 1200 kg per cubic meter for target extraterrestrial bodies which are a factor of approximately two lower in gravity than on earth.

11. The method as recited in claim 4, wherein the pycnometer density of the low-density fine particulate material additive is less than 150 kg per cubic meter for target extraterrestrial bodies that have effective surface gravity as low as the moon, or lower.

12. The method as recited in claim 4, wherein the blended regolith simulant material comprises approximately one part by volume of the original regolith simulant material to N parts by volume of the low-density fine particulate material additive, where N is generally greater than one less than the ratio of the gravitational acceleration on the surface of the earth to the gravitational acceleration on the surface of the target extraterrestrial body and generally lies in the range obtained from the formula (F−1)≦N≦ρₛ(F−1)/(ρₛ−Fρ_{b}), where F is the ratio of gravitational acceleration on earth to that on the target extraterrestrial body, ρₛ is the bulk density of original regolith simulant material, and ρ_{b} is the bulk density of the low-density fine particulate additive.

13. The method as recited in claim 4, wherein the low-density fine particulate material additive comprises solid organic polymer particles, screened or sieved to be in a size range smaller than 500 μm, and without a significant mass fraction smaller than 10 μm.

14. The method as recited in claim 13, wherein the solid organic polymer particles are screened or sieved to be generally in the same size range as particles in the original regolith simulant material.

15. The method as recited in claim 13, wherein the solid organic polymer particles have been agglomerated with a binder to create fine non-spherical particles prior to screening or sieving.

16. The method as recited in claim 15, wherein the agglomerated solid organic polymer particles are screened or sieved to be generally in the same size range as particles in the original regolith simulant material.

17. The method as recited in claim 4, wherein the low-density fine particulate material additive comprises a rigid closed pore foam material, granulated and screened or sieved to be smaller than one millimeter without a significant mass fraction smaller than 10 μm.

18. The method as recited in claim 17, wherein the rigid closed pore foam material is granulated and screened or sieved to be generally in the same size range as particles in the original regolith simulant material.

19. The method as recited in claim 4, wherein the low-density fine particulate material additive comprises an organic closed pore foam material in a size range below two millimeters.

20. The method as recited in claim 19, wherein the organic closed pore foam material is granulated and screened or sieved to be generally in the same size range as particles in the original regolith simulant material without a significant mass fraction smaller than 10 μm.

21. The method as recited in claim 4, wherein the low-density fine particulate material additive comprises an open-pore foam material.

22. The method as recited in claim 21, wherein the open-pore foam material is granulated and screened or sieved to be generally in the same size range as particles in the original regolith simulant material without a significant mass fraction smaller than 10 μm.

23. The method as recited in claim 4, wherein the low-density fine particulate material additive comprises generally spherical, low density, hollow glass bubbles screened or sieved to be smaller than 300 μm without a significant mass fraction smaller than 10 μm.

24. The method as recited in claim 23, wherein the hollow glass bubbles are screened or sieved to be generally in the same size range as the original regolith simulant material.

25. The method as recited in claim 23, wherein the hollow glass bubbles have been agglomerated with a suitable binder to create non-spherical fine particulates, and screened or sieved so that the non-spherical fine particulates are smaller than one millimeter and without a significant mass fraction of particles smaller than 10 μm.

26. The method as recited in claim 25, wherein the non-spherical fine particulates are screened or sieved so that they are generally in the same size range as the original regolith simulant material.

27. A method comprising the steps of:
screening or sieving a low-density fine particulate material additive comprising generally spherical, low density, hollow glass bubbles to be smaller than 300 μm without a significant mass fraction smaller than 10 μm;
agglomerating the glass bubbles with a binder to create non-spherical fine particulates;
screening or sieving the low-density fine particulate material additive to be smaller than one millimeter, generally in the same size range as an original regolith simulant, and without a significant mass fraction of particles smaller than 10 μm;
blending a first part comprising the low-density fine particulate material additive with a second part comprising the original regolith simulant material for producing a lower bulk density blended regolith simulant material having gravity-driven flow properties that resemble those that the original regolith material would have under a reduced gravity of a target extraterrestrial body.

28. The method as recited in claim 27, further comprising the step of screening or sieving the original regolith simulant material for separating out, and discarding, coarsest particles before blending.

29. The method as recited in claim 27, further comprising the step of adjusting a ratio of the first part to the second part for achieving an approximate bulk density of the blended regolith simulant material that is reduced from a bulk density of the original regolith simulant material by roughly a same factor as gravity on the target extraterrestrial body is reduced from the earth's surface gravity level.

30. The method as recited in claim 27, wherein the blended regolith simulant material comprises approximately one part by volume of the original regolith simulant material to N parts by volume of the low-density fine particulate material additive, where N is generally greater than one less than the ratio of the gravitational acceleration on the surface of the earth to the gravitational acceleration on the surface of the target extraterrestrial body and generally lies in the range obtained from the formula (F−1)≦N≦ρₛ(F−1)/(ρₛ−Fρ_{b}), where F is the ratio of gravitational acceleration on earth to that on the target extraterrestrial body, ρₛ is the bulk density of original regolith simulant material, and ρ_{b} is the bulk density of the low-density fine particulate additive.

31. A blended regolith simulant material comprising:
one part by volume of original regolith simulant material to N parts by volume of a low-density fine particulate material additive, where N is generally greater than one less than the ratio of the gravitational acceleration on the surface of the earth to the gravitational acceleration on the surface of a target extraterrestrial body and generally lies in the range obtained from the formula (F−1)−N≦ρₛ(F−1)/(ρₛ−Fρ_{b}), where F is the ratio of gravitational acceleration on earth to that on the target extraterrestrial body, ρₛ is the bulk density of original regolith simulant material, and ρ_{b} is the bulk density of the low-density fine particulate additive.

32. The blended regolith simulant material as recited in claim 31, wherein the low-density fine particulate material additive comprises at least one element chosen from a list comprised of solid organic polymer particles, rigid closed pore foam material, rigid closed pore foam material, open-pore foam material, and generally spherical, low density, hollow glass bubbles.
